(19) United States
(12) Patent Application Publication
(10) Pub. No.: US 2006/0031892 A1
(43) Pub. Date: Feb. 9, 2006

(54) Prevention of advertisement skipping

(75) Inventor: Noam Cohen, Binyamina (IL)

Correspondence Address: Ladas & Parry, 26 West 61st Street, New York, NY, 10023, US

(73) Assignee: BITBAND TECHNOLOGIES LTD.

(21) Appl. No.: 11/190,764

(22) Filed: Jul. 27, 2005

Related U.S. Application Data
(60) Provisional application No. 60/599,475, filed on Aug. 5, 2004.

(51) Int. Cl. H04N 7/173

(52) U.S. Cl. 725/88; 725/102; 725/86

(57) ABSTRACT

A method for delivering digital media includes transmitting a stream of the digital media to be played by a client at a predefined play speed, the stream comprising main content and, in predetermined intervals, differentiated content. In response to a request from the client to pass over a portion of the stream at a speed different from the play speed, the client is permitted to pass over the main content in the portion of the stream at the different speed, but is constrained to play the differentiated content in at least one of the intervals in the portion at the play speed.

### CROSS-REFERENCE TO RELATED APPLICATION

This application claims the benefit of U.S. Provisional Patent Application 60/599,475, filed Aug. 6, 2004, whose disclosure is incorporated herein by reference.

### FIELD OF THE INVENTION

The present invention relates generally to control of streamed data transmission, and specifically to services that provide streamed digital content, such as digital video, on demand.

### BACKGROUND OF THE INVENTION

Video service providers derive a substantial part of their revenues from advertisements that are inserted into the video program. Viewers watching the program in real time have little choice but to watch the advertisements (or switch to another channel). Alternatively, the viewer may record programs on a video cassette recorder (VCR) or digital personal video recorder (PVR), after which it is possible to skip over the advertisements upon playback. A number of methods have been proposed in order to induce viewers of recorded programs to watch advertisements. For example, U.S. patent application Publication 2001/0049820 describes a method for enhancing digital video recorder television advertising viewership by authoring the first or last number of seconds of a commercial break to provide a “teaser,” which is meant to entice the viewer to watch multiple commercials instead of skipping the commercial break using the fast forward or jump functions.

New network-based streaming video-on-demand (VOD) services are currently emerging, with the aim of replacing or supplementing the functionality of the home VCR or PVR. In these services, a video provider records programs at a central location. The service provider typically has much more storage space than the home PVR, and is capable of recording many programs simultaneously. Subscribers may then select from a large range of programs for viewing at any desired time. One example of such services is network-based personal video recorder (NPVR) service, which provides similar functionality to the home PVR, except that recording and management are performed at the service provider's premises. Another example is time-shifted TV, in which the service provider records a whole channel and enables users to select the time to start watching desired programs.

Skipping advertisements is also a problem in the network-based VOD environment. One possible solution to this problem is described in U.S. patent application Publication 2004/0103429: When a user fast-forwards or rewinds a commercial, alternate commercial(s) may be accessed for display in place of the original commercial. The duration of the alternate commercial(s) corresponds to the duration of the original commercial at the fast-forward or rewind speed controlled by the user.

### SUMMARY OF THE INVENTION

In order to make streaming VOD attractive to users, service providers would like to allow viewers to fast-forward and skip over parts of a program. On the other hand, service providers require the cooperation of advertisers and commercial content providers, who have a strong interest in preventing viewers from skipping over or otherwise curtailing advertisements. Embodiments of the present invention provide methods and systems that enable VOD service providers to address these contradictory needs.

In embodiments of the present invention, certain intervals in a main stream of digital media content (such as a video stream) are marked for insertion of differentiated content, such as advertisements. After insertion of the desired content into the marked intervals, the stream is transmitted by a server to be played by a client, such as a home video subscriber.

While viewing the content, the client may ask to pass over a portion of the stream at a speed that is different from the normal play speed. “Passing over,” in the context of the present patent application and in the claims, may mean using a fast forward or skip function (which may include any sort of random access request, such as “seek” or “jump”), for example. Alternatively or additionally, such “passing over” may optionally include slow-motion play or any other client-initiated request to deviate from the normal play speed and/or sequence of the content. When the server receives the client request, it permits the client to pass over the main content at the different speed, typically by transmitting the stream to the client so that the content is displayed at a higher or lower speed or by jumping forward or back through the content. Upon encountering a marked interval of the differentiated content, however, the server typically constrains the client to play the differentiated content at normal play speed. The client may thus navigate freely through the main content, at any available speed, but is meanwhile prevented from skipping over the advertisements.

There is therefore provided, in accordance with an embodiment of the present invention, a method for delivering digital media, including:

transmitting a stream of the digital media to be played by a client at a predefined play speed, the stream including main content and, in predetermined intervals, differentiated content;

receiving a request from the client to pass over a portion of the stream at a speed different from the play speed; and

responsively to the request, permitting the client to pass over the main content in the portion of the stream at the different speed, while constraining the client to play the differentiated content in at least one of the intervals in the portion at the play speed.

In disclosed embodiments, transmitting the stream includes providing start tags in the main content indicating start locations of the intervals, inserting the differentiated content in the at least one of the intervals responsively to the start tags, adding end tags to the stream to indicate an end location of the at least one of the intervals, and recording the start and end locations responsively to the start and end tags, for use in responding to the request from the client. In one embodiment, transmitting the stream includes removing the start and end tags from the stream before conveying the stream to the client. Typically, constraining the client includes, responsively to the request, identifying at least one of the recorded start and end locations in the portion of the stream, and enforcing the play speed between the start and end locations.

In one embodiment, receiving the request includes receiving a fast forward (FFWD) and a slow motion request, and permitting the client includes transmitting the main content to the client at the different speed, and constraining the client includes transmitting the differentiated content in the at least one of the intervals at the play speed.

In another embodiment, receiving the request includes receiving a random access request to skip the portion of the stream, and constraining the client includes transmitting the differentiated content in the at least one of the intervals at the play speed before fulfilling the random access request.

In a disclosed embodiment, transmitting the stream includes transmitting a digital video program to the client of a video-on-demand service, wherein transmitting the digital video program includes transmitting a MPEG stream. Typically, the differentiated content includes one or more advertisements.

There is also provided, in accordance with an embodiment of the present invention, apparatus for delivering digital media, including:

a memory, which is configured to store digital media, including main content and, in predetermined intervals, differentiated content; and

a server, which is coupled to transmit a stream of the digital media to be played by a client at a predefined play speed, and which is adapted, upon receiving a request from the client to pass over a portion of the stream at a speed different from the play speed, to permit the client to pass over the main content in the portion of the stream at the different speed, while constraining the client to play the differentiated content in at least one of the intervals in the portion at the play speed.

There is additionally provided, in accordance with an embodiment of the present invention, a computer software product, including a computer-readable medium in which program instructions are stored, which instructions, when read by a computer, cause the computer to access stored digital media, including main content and, in predetermined intervals, differentiated content, and to transmit a stream of the digital media to be played by a client at a predefined play speed, and further cause the computer, upon receiving a request from the client to pass over a portion of the stream at a speed different from the play speed, to permit the client to pass over the main content in the portion of the stream at the different speed, while constraining the client to play the differentiated content in at least one of the intervals in the portion at the play speed.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for providing NPVR service, in accordance with an embodiment of the present invention;

FIGS. 2A, 2B and 2C are time lines that schematically illustrate a stream of digital video content at various stages in processing, in accordance with an embodiment of the present invention;

FIG. 3 is a flow chart that schematically illustrates a method for handling a user FFWD command submitted to a NPVR service, in accordance with an embodiment of the present invention; and

FIG. 4 is a flow chart that schematically illustrates a method for handling a user seek command submitted to a NPVR service, in accordance with an embodiment of the present invention.

### DETAILED DESCRIPTION OF EMBODIMENTS

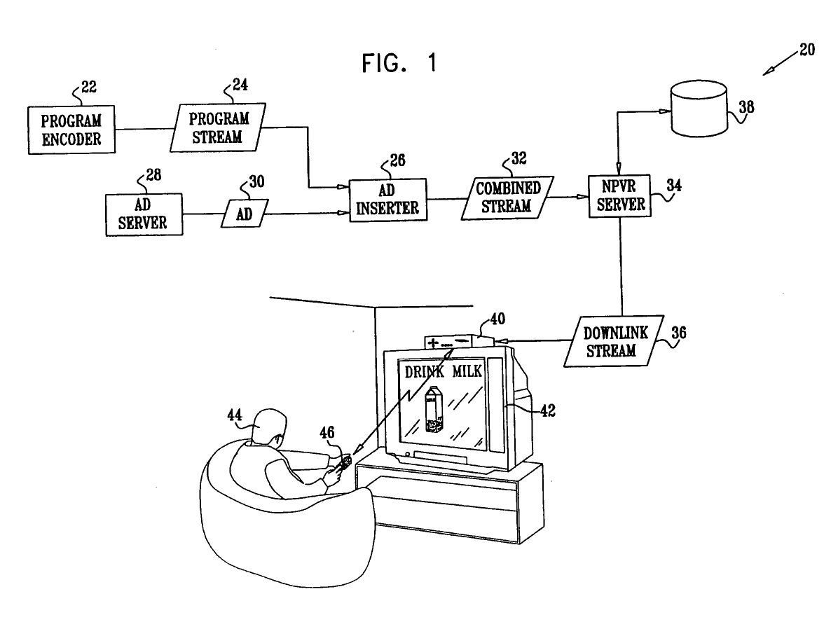

FIG. 1 is a block diagram that schematically illustrates a system 20 for providing network personal video recorder (NPVR) service, in accordance with an embodiment of the present invention. A program encoder 22 generates a program stream 24 of digital media data. In the present embodiment, the program stream is assumed to comprise digital video data, which is typically compressed in accordance with an applicable standard. For example, program stream 24 may comprise a MPEG-2 transport stream, as specified by ISO/IEC standard 13818-2 (1996-05), entitled Information Technology—Generic Coding of Moving Pictures and Associated Audio Information: Video. Alternatively, the principles of the present invention may be applied in transmission of streaming digital media of other types, as well.

Program stream 24 contains encoded program content with tags (mark-in points) that mark potential locations for inserting advertisements. Typically, these tags comprise data structures that are inserted into the digital media and then decoded for further processing downstream. A tag format suitable for use in MPEG-2 streams is described, for example, in ANSI/SCTE standard 35 2004, entitled Digital Program Insertion Cueing Message for Cable (promulgated by the Society of Cable Telecommunications Engineers, Exton, Pa., and available at www.stce.org), which is incorporated herein by reference.

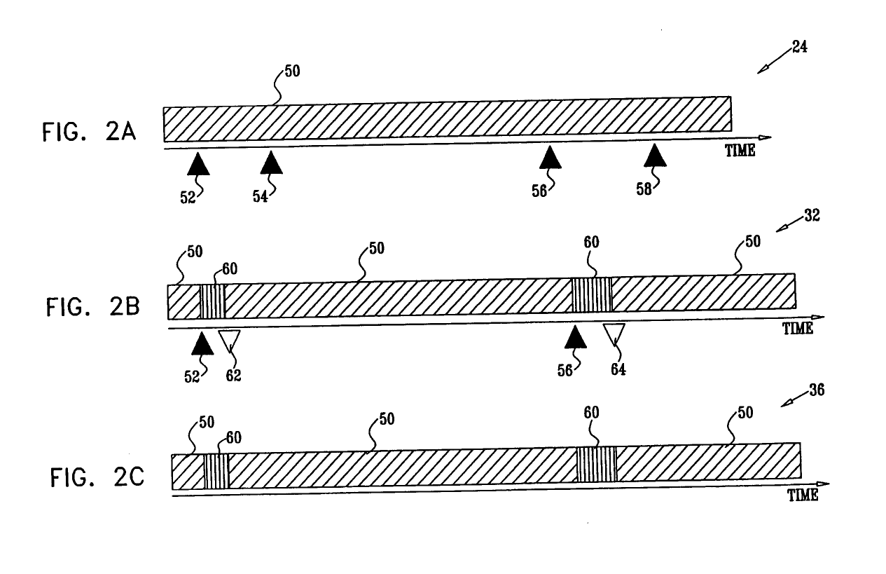

Program stream 24 is processed by an ad inserter 26, which receives advertisements 30 from an ad server 28 and inserts the advertisements in some or all of the marked locations to generate a combined program stream 32. The ad inserter removes the tags that refer to locations that were not used for insertion of advertisements, while adding tags to mark the end of each ad. Thus, as shown below in FIG. 2B, each ad occupies an interval in the combined program stream, which is delineated by a start tag and an end tag.

Combined stream 32 passes to a NPVR server 34, which stores the combined stream in a memory 38. While storing the stream, the NPVR server notes the locations of the tags and thus creates and maintains a list of ad intervals in the stream, typically in the form of <start time, end time> pairs. Optionally, after noting the interval locations, the NPVR server removes all the remaining tags from the stored video data. Although tags remaining in the data stream will typically be ignored by home video players, it is desirable that the tags be removed in order to prevent malicious users from using the tags to locate and remove advertisements from recorded copies (typically illegal) that they may make of the video stream.

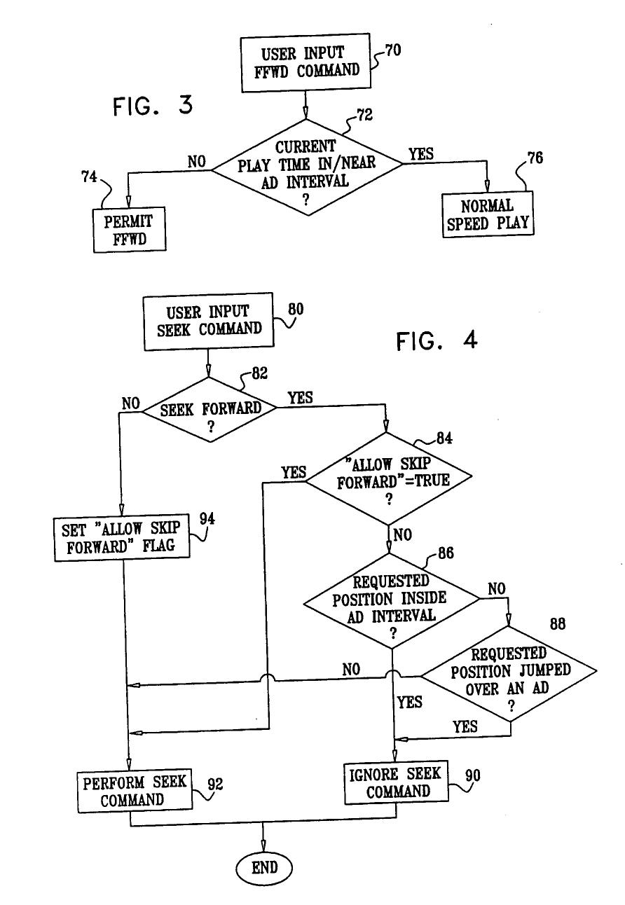

When a user 44 selects a program for viewing, NPVR server 34 transmits a downlink stream 36 from memory 38 to a client device 40 at the user premises. Typically, the client device comprises a suitable decoder, such as a MPEG-compliant set-top box, which decompresses the stream for display on a television 42. (The present embodiment may be implemented using conventional set-top boxes without modification.) During the program, user 44 may operate a remote control 46 to request a fast forward (FFWD) or fast backward (FBWD) operation, or possibly to jump ahead or back in the program. Client device 40 receives and conveys these requests to NPVR server 34. The NPVR server handles these requests using the list of ad intervals in memory 38, so as to prevent the user from skipping over advertisements. This aspect of the operation of the NPVR server is described in detail hereinbelow with reference to FIG. 3. Of course, although only one user is shown in FIG. 1 for the sake of simplicity, in practice the NPVR server typically serves many users simultaneously.

Typically, NPVR server 34 comprises a general-purpose computer, with suitable interface hardware for receiving, transmitting and storing digital media. The NPVR server is programmed in software to carry out the functions described herein. This software may be conveyed to the server in electronic form, over a network, for example, or it may alternatively be provided on tangible media, such as optical, magnetic or non-volatile electronic storage media. Alternatively or additionally, some or all of the functions of the NPVR server may be performed by dedicated hardware processing circuits. The other elements of system 20 (such as encoder 22, ad server 28 and ad inserter 26) may be similarly constructed and programmed.

FIGS. 2A, 2B and 2C are time lines that schematically illustrate digital media streams as they appear at different points in system 20, in accordance with an embodiment of the present invention. FIG. 2A shows program stream 24 that is output by encoder 22. The program stream comprises main content 50, such as an MPEG-2 encoded television program, with start tags 52, 54, 56, 58 marking possible locations for ad insertion. The start tags are typically inserted at appropriate points in main content 50 by an author, producer or editor of the content.

FIG. 2B shows combined content 32 following insertion of advertisements 60 at the locations indicated by tags 52 and 56. The advertisements are similarly provided as MPEG-2 content. Ad inserter 26 marks the end of each advertisement interval with an end tag 62, 64. Tags 54 and 58, which marked unused ad locations, are removed from stream 32. It is important to understand that the presence of tags 52, 62, 56 and 64 in stream 32 is not by itself sufficient to prevent a user from skipping over advertisements 60. Rather, the tags are markers for use by the NPVR server in determining which user operations are permitted in different parts of the content stream.

FIG. 2C shows downlink stream 36 as transmitted by NPVR server 34. As noted above, the NPVR server has removed tags 52, 62, 56 and 64, while noting the start and end times of the corresponding ads 60 in memory 38. As a result, stream 36 appears to decoder 40 to contain a single, uninterrupted MPEG-2 transport stream.

FIG. 3 is a flow chart that schematically illustrates a method by which NPVR server 34 handles user requests to pass over a part of the content in stream 36, in accordance with an embodiment of the present invention. In this example, user 44 submits a request to fast-forward (FFWD) through a part of the stream, at a user input step 70. This same method may be used, mutatis mutandis, to handle slow motion playback requests. A method for handling random access request is shown below in FIG. 4.

In response to the user request, the NPVR server checks the user's current play location (play time) in stream 36 against the list of ad intervals 60 in memory 38, at a location checking step 72. As long as the current position is not in or immediately before one of the ad intervals, the NPVR server permits the FFWD, at a fast forward step 74. In this case, the NPVR server transmits stream 36 to client device 40 at increased speed, as described, for example, in U.S. patent application Ser. No. 10/978,215, filed Oct. 28, 2004, which is assigned to the assignee of the present patent application and whose disclosure is incorporated herein be reference. Alternatively, other methods of increased-speed transmission may be used, as are known in the art.

On the other hand, if NPVR server 34 determines at step 72 that the stream is currently within or about to reach one of the ad intervals, the server refuses the FFWD request, and transmission proceeds at the normal play speed, at a normal speed step 76. Similarly, during FFWD playback at step 74, if the current play location arrives at the start of an ad interval, the NPVR server may automatically change to normal speed transmission until the end of the interval. Additionally or alternatively, the NPVR server may be programmed with more complex decision logic, so that the user is permitted to fast-forward through some ad intervals but not others.

Typically, the NPVR server is programmed to permit fast-backward (FBWD) operation. optionally, if a certain FBWD passed through all or part of an advertisement, and the user immediately thereafter makes a FFWD request, the server may in this case permit the user to FFWD through the advertisement.

If NPVR server 34 supports random access functions (i.e., skip, jump and/or seek operations), the server may limit these functions, as well, to prevent skipping over advertisements. Thus, if the server determines that there is an ad interval between the source and destination locations in the stream, the server may refuse the jump or seek request or, alternatively, may jump to the start of the nearest ad interval instead of the requested location.

FIG. 4 is a flow chart that schematically illustrates a method for handling a user seek request, in accordance with an embodiment of the present invention. This method is invoked upon receipt of a seek command from user 44, at a seek request step 80. Server 34 determines whether the user has asked to skip forward or backward in the stream, at a direction checking step 82. Generally speaking, backward seek is permitted, and the user is also permitted thereafter to return forward to the source location in the stream where the seek began (as indicated by the use of an “allow skip forward” flag that is set for this purpose). Seek forward is otherwise permitted only if the seek does not cross all or part of an ad interval.

After determining at step 82 that a forward seek has been requested, server 34 checks the status of the “allow skip forward” flag, at a flag checking step 84. As long as the flag is not set, the server determines whether the destination of the seek falls within an ad interval, at an ad coincidence checking step 86, or whether the seek will pass over an ad interval, at an ad skip checking step 88. If the result of either of these steps is positive, server 34 ignores the seek command, at a seek refusal step 90. Alternatively, the server may skip to the beginning of the first ad interval on the seek path and then play the advertisement. On the other hand, if the result of both of steps 86 and 88 is negative, server 34 skips to the requested seek destination, at a seek performance step 92.

Upon determining at step 82 that the user has asked to seek backward through the stream, server 34 sets the “allow skip forward” flag, at a flag setting step 94. The server then skips to the requested destination at step 92. When setting the flag at step 94, the server may also record the source location where the seek began. In this case, when the server determines at step 84 that the flag is set, it also reads the source location and, at step 92, permits the user to skip forward only up to the source location before resetting the flag and returning to check for ad intervals at steps 86 and 88. Similarly, if the user asks to play the stream beginning from the destination of the backward seek, the flag is reset when the stream subsequently passes the source location. Server 34 may also be programmed to permit the user to fast-forward freely from the seek destination location up to the source location.

Although the embodiment described above refers specifically to insertion of advertisements into a NPVR MPEG-2 video stream, the principles of the present invention may similarly be applied to other provider models, in order to enforce streaming policies with respect to substantially any sort of differentiated content within streams of digital media of various types, such as MPEG-4 part 10 or Microsoft® Windows Media Video (WMV). It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for delivering digital media, comprising:
transmitting a stream of the digital media to be played by a client at a predefined play speed, the stream comprising main content and, in predetermined intervals, differentiated content;
receiving a request from the client to pass over a portion of the stream at a speed different from the play speed; and
responsively to the request, permitting the client to pass over the main content in the portion of the stream at the different speed, while constraining the client to play the differentiated content in at least one of the intervals in the portion at the play speed.

2. The method according to claim 1, wherein transmitting the stream comprises:
providing start tags in the main content indicating start locations of the intervals;
inserting the differentiated content in the at least one of the intervals responsively to the start tags;
adding end tags to the stream to indicate an end location of the at least one of the intervals; and
recording the start and end locations responsively to the start and end tags, for use in responding to the request from the client.

3. The method according to claim 2, wherein transmitting the stream comprises removing the start and end tags from the stream before conveying the stream to the client.

4. The method according to claim 2, wherein constraining the client comprises, responsively to the request, identifying at least one of the recorded start and end locations in the portion of the stream, and enforcing the play speed between the start and end locations.

5. The method according to claim 1, wherein receiving the request comprises receiving a fast forward (FFWD) and a slow motion request, and wherein permitting the client comprises transmitting the main content to the client at the different speed, and constraining the client comprises transmitting the differentiated content in the at least one of the intervals at the play speed.

6. The method according to claim 1, wherein receiving the request comprises receiving a random access request to skip the portion of the stream, and wherein constraining the client comprises transmitting the differentiated content in the at least one of the intervals at the play speed before fulfilling the random access request.

7. The method according to claim 1, wherein transmitting the stream comprises transmitting a digital video program to the client of a video-on-demand service.

8. The method according to claim 7, wherein transmitting the digital video program comprises transmitting a MPEG stream.

9. The method according to claim 1, wherein the differentiated content comprises one or more advertisements.

10. Apparatus for delivering digital media, comprising:
a memory, which is configured to store digital media, comprising main content and, in predetermined intervals, differentiated content; and
a server, which is coupled to transmit a stream of the digital media to be played by a client at a predefined play speed, and which is adapted, upon receiving a request from the client to pass over a portion of the stream at a speed different from the play speed, to permit the client to pass over the main content in the portion of the stream at the different speed, while constraining the client to play the differentiated content in at least one of the intervals in the portion at the play speed.

11. The apparatus according to claim 10, wherein the digital content comprises start tags and end tags respectively indicating start locations and end locations of the intervals in the main content, and wherein the server is adapted to record the start and end locations responsively to the start and end tags, for use in responding to the request from the client.

12. The apparatus according to claim 11, wherein the server is adapted to remove the start and end tags from the stream before conveying the stream to the client.

13. The apparatus according to claim 11, wherein the server is adapted, in response to the request, to identify at least one of the recorded start and end locations in the portion of the stream responsively to the start and end tags, and to enforce the play speed between the start and end locations.

14. The apparatus according to claim 10, wherein the request comprises at least one of a fast forward (FFWD) and a slow motion request, and wherein the server is adapted, responsively to the request, to transmit the main content to the client at the different speed, and to transmit the differentiated content in the at least one of the intervals to the client at the play speed.

15. The apparatus according to claim 10, wherein the request comprises a random access request to skip the portion of the stream, and wherein the server is adapted, responsively to the request, to transmit the differentiated content in the at least one of the intervals at the play speed before fulfilling the random access request.

16. The apparatus according to claim 10, wherein the digital media comprise a digital video program, and wherein the server is adapted to stream the digital video program to the client on demand.

17. The apparatus according to claim 16, wherein the stream comprises a MPEG stream.

18. The apparatus according to claim 10, wherein the differentiated content comprises one or more advertisements.

19. A computer software product, comprising a computer-readable medium in which program instructions are stored, which instructions, when read by a computer, cause the computer to access stored digital media, comprising main content and, in predetermined intervals, differentiated content, and to transmit a stream of the digital media to be played by a client at a predefined play speed, and further cause the computer, upon receiving a request from the client to pass over a portion of the stream at a speed different from the play speed, to permit the client to pass over the main content in the portion of the stream at the different speed, while constraining the client to play the differentiated content in at least one of the intervals in the portion at the play speed.
